(19) United States
(12) Patent Application Publication
(10) Pub. No.: US 2025/0313984 A1
(43) Pub. Date: Oct. 9, 2025

(54) ELECTROLYTIC SYSTEM FOR DEFOULING, STRUCTURES COMPRISING SAID SYSTEM AND METHOD FOR DEFOULING A SUBMERGED STRUCTURE

(71) Applicant: TITANIUM TECHNOLOGY S.L., Madrid (ES)

(72) Inventor: Alejandro SAMANIEGO MIRACLE, Madrid (ES)

(21) Appl. No.: 18/864,959

(22) PCT Filed: May 15, 2023
(86) PCT No.: PCT/EP2023/062912

§ 371 Date: Nov. 12, 2024

(30) Foreign Application Priority Data
May 13, 2022 (EP) 22382464.0

(51) Int. Cl. C25F 1/00; B08B 17/00; B63B 59/04; C25F 7/00; F16L 9/14

(52) U.S. Cl. CPC C25F 1/00; C25F 7/00; B08B 17/00; B63B 59/04; F16L 9/14

(57) ABSTRACT

An electrolytic system for defouling includes a first substrate, the first substrate having titanium, wherein a surface of the first substrate intended to be in contact with water is defined in the first substrate, a second conductive substrate provided with a surface intended to be in contact with water, the electrolytic system includes an electrical power source, the electrical power source being connected in series between the first and second substrate, so that an electrolytic circuit can be established formed by water, the first substrate, the second substrate and the electrical power source that provides electrical energy, wherein the power source is configured to provide a current density such that the first substrate operates as anode, to invert cyclically the polarity of the circuit, such that the first substrate and the second substrate alternate their functions as anodes or cathodes cyclically, and/or to provide a pulsed current density.

### CROSS-REFERENCE TO RELATED APPLICATIONS

This application is a 35 U.S.C. § 371 National Stage patent application of PCT/EP2023/062912, filed on 15 May 2023, which claims the benefit of European patent application 22382464.0, filed on 13 May 2022, the disclosures of which are incorporated herein by reference in their entirety.

### TECHNICAL FIELD

The disclosure belongs to the field of electrolytic systems for defouling submerged structures by applying currents to the surfaces immerged in the water.

### BACKGROUND

Conventional electrolytic systems comprise a first substrate, the first substrate comprising titanium, wherein a surface of the first substrate intended to be in contact with water is defined in the first substrate, a second conductive substrate provided with a surface intended to be in contact with water, the electrolytic system comprising an electrical power source, the electrical power source being connected in series between the first and second substrate, so that an electrolytic circuit can be established formed by water, the first substrate, which operates as anode, the second substrate which operates as cathode, and the electrical power source that provides electrical energy.

An example of such an electrolytic system is disclosed in the patent document JP2003328164A which relates to a method for preventing adhesion of marine organism to titanium ships.

This document describes the application to a submerged substrate containing titanium of various potentials (specifically reference tensions with respect to the reference electrode (silver/Silver Chloride in seawater), of the order of 1,2 V_{Ag/AgCl}, with a view to generating species at the anode that kill microorganisms, with a view to reducing fouling.

The document discloses experiments where a 50 mm×30 mm is immerged for three months, and then the presence of fouling is checked. The experiments, according to the document, show that on the samples at 1,2 V_{Ag/AgCl} no marine organisms were observed.

The inventor of the present application tried to reproduce these results but using bigger plates, in order to obtain realistic measures, since the hull of a boat will typically tens, hundreds or even thousands or square meters exposed to the water. The plates used were of 0.6 m². However, when applying reference tensions of 1.2-2 or even 3V_{Ag/AgCl}, the results were poor, and the surface of titanium covered with algae and barnacle suggesting that the electrolytic solution was not viable in a bigger scale and longer periods of time.

Throughout the present description, it is important to point out that a titanium electrode is not an activated titanium electrode (MMO or Platinum plated) where the surface has been modified in order to stabilize it and facilitate current output when subjected to an electrical signal.

The document “Development of an electrochemical antifouling system for seawater cooling pipelines of power plants using titanium” discloses a titanium based substrates working at a potential of around 0.9 V_{Ag/AgCl} so as not to generate chlorine or change pH, by using two types of signals:
A fixed signal with galvanostatic control at 50/100 mA/m². It starts with the application of 0.9 V_{Ag/AgCl} but it discloses that to maintain that current the potential must be increase to 6/7 V_{Ag/AgCl}. (it is pointed out that this fact has been checked by the inventors of the present disclosure).
Signal alternated with anode cycle at 0.9 V_{Ag/AgCl} and cathodic signal at −0.3/−0.9 V_{Ag/AgCl}.

According to the paper, a main goal is trying to avoid the generation of chlorine and pH changes. We point out that the current densities disclosed therein do not correspond to those indicated in the study graphs.

The current densities described in the paper are inconsistent with the data presented in the graphs of the article and some of the photos show painted test coupons and not bare as would be necessary to achieve the antifouling effect described, unless they are conductive paints such as those described in other works by this same group (Electrochemical Prevention of Biofouling-Matsunaga 2000-68_847) where they describe a signal similar to the one exposed in the article for conductive paints.

In any case, it should be noted that the paper does not specify anything about the iron counter electrode that they use, which under the conditions described with anodic cycles necessarily has to corrode and on which, under galvanostatic conditions, calcareous salts and biofouling must precipitate, such as those shown in the FIGS. 18 and 19 and that their proposal focuses on keeping substrate 1 clean and does not take substrate 2 into account, which in many applications can limit the application of the technology as explained below.

### DISCLOSURE SUMMARY

For overcoming the aforementioned limitations, the present disclosure proposes an electrolytic system for defouling comprising a first substrate, the first substrate comprising titanium, wherein a surface of the first substrate intended to be in contact with water is defined in the first substrate, a second conductive substrate provided with a surface intended to be in contact with water, the electrolytic system comprising an electrical power source, the electrical power source being connected in series between the first and second substrate, so that an electrolytic circuit can be established formed by water, the first substrate, the second substrate and the electrical power source that provides electrical energy, wherein the power source is configured to provide a current density such that the first substrate operates as anode; and
to invert cyclically the polarity of the circuit, such that the first substrate and the second substrate alternate their functions as anodes or cathodes cyclically; and/or
to provide a pulsed current density.

In some embodiments, the second substrate is titanium, activated titanium or a consumable electrode, and/or the electrolytic system can comprise a plurality of second substrates and electronics is configured so that at least one of the second substrates is subjected to an anodic potential by the power source, so that this at least one of the substrates works as an anode to eliminate the calcareous salts that may have precipitated on its surface.

In some embodiments, the power source is configured to provide a current density greater than or equal to a 30 mA/m² on the surface.

In some embodiments, the electrical power source is configured to apply a cyclic signal consisting in a succession of:
a constant current whereby the first substrate operates as anode and the second substrate operates as cathode;
an inverted current whereby the first substrate operates as cathode and the second substrate operates as anode.

In some embodiments, the electrical power source is configured to apply a cyclic signal consisting in a succession of:
a pulsed current whereby the first substrate operates as anode and the second substrate operates as cathode,
an inverted current whereby the first substrate operates as cathode and the second substrate operates as anode.

In some embodiments, the Electrolytic comprises an underlying substrate, the first substrate being attached to the underlying substrate.

In some embodiments, the underlying substrate is made of steel, aluminium or bronze, the first substrate being made of pure titanium, and wherein the first substrate is made of two layers, an outer thick layer and an attachment layer, the attachment layer forming an interface between the outer layer and the underlying substrate, and preferably the attachment layer is a PVD or CVD deposited layer.

In some embodiments, the underlying substrate is made of a titanium alloy, the first substrate being made of pure titanium.

In some embodiments, the underlying substrate is made of a composite material, the first substrate being a blank made of pure titanium and having a thickness comprised between 0.1 and 4 mm.

In some embodiments, the composite material comprises resins, glass fibre, carbon fibre and/or structural plastic.

In some embodiments, the underlying substrate is made of an inner layer made of metal and an outer layer made of isolation material, the first substrate being a blank made of pure titanium and having a thickness comprised between 0.1 and 4 mm, the blank being attached to the outer layer.

In some embodiments, the first substrate is divided in a plurality of substrates, such that some of these substrates form the second substrate when inversions of polarity apply.

This option seeks to avoid biological incrustation in both substrate 1 and 2 and allows avoiding salt precipitation and biological growth in the counter electrode and the need to use auxiliary counter electrodes that in many cases are difficult to position correctly.

For example, in the case of a plate heat exchanger. Here the distance between the plates is very small and it would be necessary to position the counter electrode in the tube and the distribution of the electrical signal is difficult. In addition, the counter electrode will be filled with salts and biological incrustation, becoming able to clog pipes, heat exchangers or refrigeration circuits.

However, the signal can be applied alternately between the plates by making them work as anode and cathode alternating the signal, so that the plates remain clean, there is no precipitation of salts and the signal is propagated uniformly by having a small distance between electrodes.

To emphasize the difference form this embodiment of the present disclosure respect to what was previously reported, it is worth mentioning the document “Construction of an Electrochemical Antibiofouling System for Plate Heat Exchangers, Hitoshi Wake, Toshihiro Takimoto, Hirokazu Takayanagi, Kinichi Ozawa, Hideo Kadoi, Shigeki Mukai, Yoshinari Komura, Mina Okochi, Hiroyuki Honda, Tadashi Matsunaga”. Firstly, document proposes to work with activated titanium in the plates, which is expensive and lowers the exchange performance different from the concept of the present disclosure (that's why this document mentions such low potentials) and they propose adding an auxiliary counter electrode and a reference electrode. Their methodology makes it difficult to implement the solution and an important difference is that it aims only at the cleanliness in electrode 1 while according to the present disclosure, with the alternating signal using different parts of the structure as working electrode and counter electrode, both electrodes are kept clean.

Therefore, the present disclosure is much simpler and more viable since it involves working with non-activated titanium, avoids problems with the counter electrode, and facilitates the application of the signal.

The same can be applied to pipes where sectioning the pipe into sections allows the distance between electrodes to be maintained in a controlled manner, eliminating auxiliary counter electrodes and achieving the results of FIGS. 24 and 25 by dividing the structure in part electrically insulated from each other. In fact, we're getting results like this where the titanium interior is completely clean. The disclosure also relates to a ship, pipe, heat exchanger, propeller or shaft, among others, provided with an electrolytic system according to any of the preceding variants.

The disclosure also relates to an assembly comprising a pipe and an electrolytic system according to the variants disclosed above, comprising an inner layer that corresponds to the first substrate, the pipe comprising an intermediate layer that corresponds to a structural material to confer it rigidity, and comprising an outer metallic layer that corresponds to the second substrate.

The disclosure also relates to a method for defouling a ship, pipe, heat exchanger, propeller, shaft, turbines, in particular tidal turbines, sea chests (for ships refrigeration), hydrofoils and/or pumps components using an electrolytic system according to any of the inventive variants, which comprises:
calculating the first substrate area;
setting the electrical power source such that it provides preferably an anode potential greater than a limit to avoid biofouling in the first substrate;
a plurality of second substrates, the electrolytic being configured so that at least one of the second substrates is subjected to the same potential by the power source as the first substrate, so that this at least one of the substrates works as an anode to eliminate the calcareous salts that may have precipitated on its surface.

Finally, the disclosure also relates to a method for defouling a ship, pipe, heat exchanger, propeller, shaft, turbines, in particular tidal turbines, sea chests (for ships refrigeration), hydrofoils and/or pumps components using an electrolytic system according to any of the inventive variants, which comprises:
calculating the first substrate area;
setting the electrical power source such that it provides preferably an anode potential greater than a limit to avoid biofouling in the first substrate;
dividing the first substrate in a plurality of substrates and inverting the polarity between those substrates so that all the substrate act as anodes and cathodes avoiding biofouling growth on their surfaces, the precipitation of calcareous salts on their surface, avoid the needs of additional counter electrodes and reduce the working area and therefore the energy consumption.

### BRIEF DESCRIPTION OF THE DRAWINGS

To complete the description and in order to provide for a better understanding of the disclosure, a set of drawings is provided. Said drawings form an integral part of the description and illustrate an embodiment of the disclosure, which should not be interpreted as restricting the scope of the disclosure, but just as an example of how the disclosure can be carried out. The drawings comprise the following figures:

FIG. 1 shows a diagram of the system according to the disclosure.

FIG. 2 shows a layer scheme according to an embodiment of the disclosure wherein the titanium layer is adhered to a third substrate.

FIG. 3 shows a layer scheme according to an embodiment of the disclosure wherein the underlying substrate is in turn formed by the third substrate and an interface layer.

FIG. 4 shows a layer scheme according to an embodiment of the disclosure wherein the titanium is a blank adhered to the substrate with the interposition of an isolation material.

FIG. 5 shows a titanium plate that has been immersed and to which a potential of 3 V_{Ag/AgCl} was applied.

FIG. 6 shows an experimental setup on a ship's hull, and the adhesion result after immersion for a few months.

FIG. 7 is a zoomed photography of FIG. 6.

FIGS. 8 to 11 show plates of a system where tensions below 6 V were applied.

FIGS. 12 to 16 show plates of a system according to the disclosure.

FIG. 17 shows another plate used in the inventive conditions where an alternating signal has been applied.

FIGS. 18 and 19 shows the calcareous depositions in the cathodes, when no inversion is applied.

FIG. 20 shows a pulsed signal applied that allows to save energy.

FIGS. 21 and 22 shows a pulsed signal combined with cathodic cleaning.

FIG. 23 shows a method for renewing an anodic surface.

FIGS. 24 to 26 shows the results of the application of the disclosure to the interior of pipes (FIG. 26 shows the external part of the pipe (FIG. 25) without antifouling system). FIG. 27 shows what happens to an alloy when working above the rupture Potential.

### DETAILED DESCRIPTION OF THE DISCLOSURE DRAWINGS

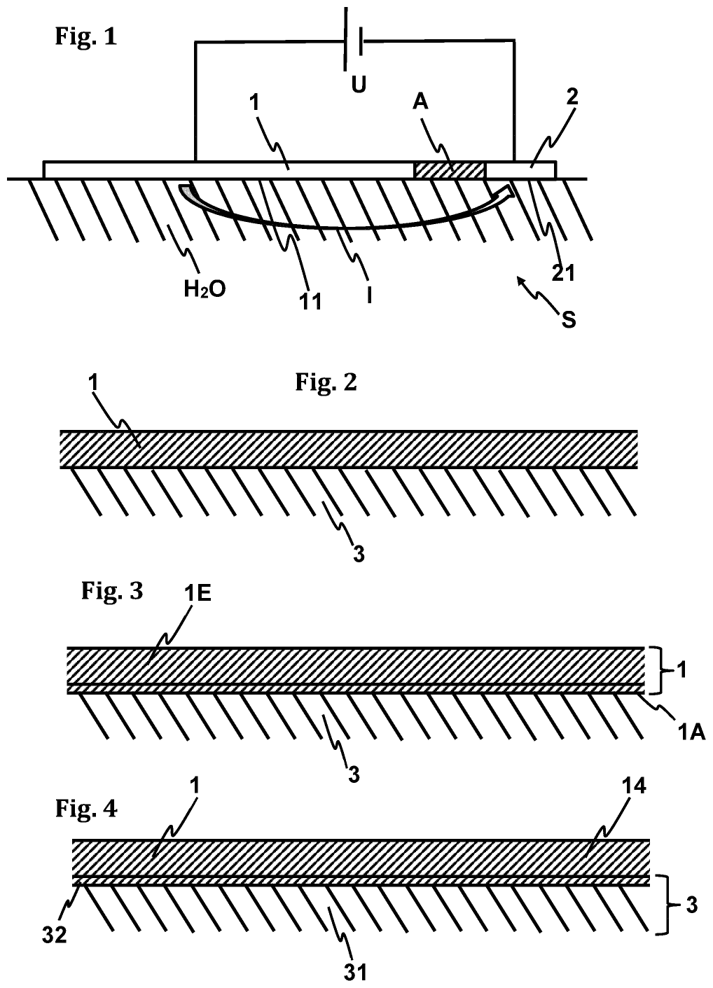

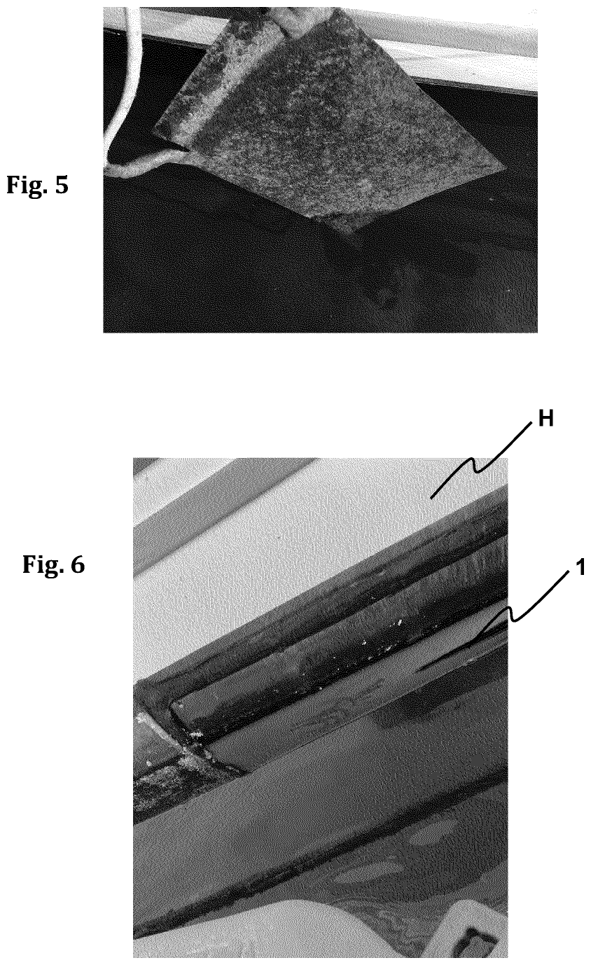

As shown in FIG. 1, 20, 21, 22 or 23, according to an embodiment, the electrolytic system S for defouling comprises a first substrate 1, the first substrate 1 comprises titanium, wherein a surface 11 of the first substrate 1 intended to be in contact with water is defined in the first substrate 1, a second conductive substrate 2 provided with a surface 21 intended to be in contact with water, the electrolytic system S comprising an electrical power source U, the electrical power source U being connected in series between the first 1 and second 2 substrate, so that an electrolytic circuit can be established formed by water, the first substrate 1, the second substrate 2 and the electrical power source U that provides electrical energy, and the power source U is configured:
to provide a current density such that the first substrate 1 operates as anode, the current density being preferably applied in a pulsed manner so as to save energy; and
to invert cyclically the polarity of the circuit, such that the first substrate 1 and the second substrate 2 alternate their functions as anodes or cathodes cyclically.

The second substrate 2 is titanium or activated titanium or a consumable electrode, and/or the electrolytic system can comprise a plurality of second substrates and the electrolytic is configured so that at least one of the second substrates 2 is subjected to an anodic potential by the power source, so that this at least one of the substrates works as an anode to eliminate the calcareous salts that may have precipitated on its surface.

Furthermore, among others, it is possible to divide the first substrate in different electrical independent surfaces that will work as substrate 1 and substrate 2 making them work alternately anodic and cathodic, eliminating the need to use counter electrodes (different from what was proposes before), and keeping both, substrate 1 and 2, clean from biofouling. In addition, polarity changes facilitate the output of anode current since they reverse superficial anodic processes and decrease the resistance of the system. Our alternating signal may be symmetrical with a similar working and counter electrode or vary depending of the area of substrate 1 and 2 but always must sufficient to avoid biofouling in both surfaces.

The structure can be divided into different areas of titanium electrically disconnected from each other, so that the signal can be applied between them alternately. With this the precipitation of salts and biological growth on the counter electrode are avoided and also the need to use the counter electrode, which in many cases is difficult to position in the correct place. For example, in the case of a plate heat exchanger. The distance between the plates is very small and it would be necessary to position the counter electrode in the tube and the distribution of the electrical signal is difficult. In addition, the counter electrode will fill with salts and biofouling. However, we can apply the signal alternately between the plates if we make them act as anode and cathode alternating the signal, so that the plates remain clean, there is no precipitation of salts and we get the signal to propagate uniformly. by having a small distance between electrodes.

In the embodiment shown in FIG. 2, the electrolytic system comprises an underlying substrate 3, the first substrate 1 being attached to the underlying substrate 3. Here the underlying substrate 3 is made of a titanium alloy, the first substrate 1 being made of pure titanium.

In another variant of the embodiment shown in FIG. 2 the underlying substrate 3 is made of a composite material, the first substrate 1 being a blank 14 made of pure titanium and having a thickness comprised between 0.1 and 4 mm. The composite material 3 can comprise resins, glass fibre, carbon fibre and/or structural plastic.

FIG. 3 depicts an embodiment wherein the underlying substrate 3 is made of steel, aluminium or bronze, the first substrate 1 being made of pure titanium, and wherein the first substrate is made of two layers, an outer thick layer 1E and an attachment layer 1A, the attachment layer 1A forming an interface between the outer layer 1E and the underlying substrate 3, and preferably the attachment layer 1A is a PVD or CVD deposited layer.

FIG. 4 depicts an embodiment wherein the underlying substrate 3 is made of an inner layer 31 made of metal and an outer layer 32 made of isolation material, the first substrate 1 being a blank 14 made of pure titanium and having a thickness comprised between 0.1 and 4 mm, the blank 14 being attached to the outer layer.

### Voltages and Current Densities

To arrive at the preferred voltages and current densities, tests were carried out by applying electrical signals in different ways. From potentiostatic control, galvanostatic control, constant voltage pulses, to alternate pulses or periodic pulses. The tests were standardized by using grade 2 titanium electrodes for both the anode and the cathode. Test were also performed using other material for the cathode, like for example steel.

In the initial stages, the system evolves over time and the resistance of the anode varies considerably due to the anodizing that occurs on its surface. The resistance of the system increases as time passes. Salts precipitate on the cathode. This an expected effect.

Then the following tests were carried on by applying a constant voltage. The system current follows Ohm's law and it must be taken into account that the system resistance changes over time due to the reactions that occur on the electrodes, mainly the anodizing reaction produced in the titanium anode. In all the tests, both the current and the tension were measured.

As a summary, the inventor, as will be made evident below, concluded from the tests that there is a critical current from which an antifouling effect on the titanium surface begins to be observed. Below that current, even though the electrode is anodically polarized, algae continue to grow.

When the applied voltage is less than 6V in constant signals, an effect on the biofouling is seen but the biofouling is not completely eliminated because the minimal anodic current need to avoid biofouling is not reached

The following table shows the parameters used in the non-successful tests (plate used was 0.6 m² in area):

| | | | |
|---|---|---|---|
| | Applied | Anode | Current density |
| Current | tension | Potential | mA/m2 |

| | | | | | | |
|---|---|---|---|---|---|---|
| 17.7 | mA | 5.5 | V | 5.45 | V_{AgAgCl} | 28.3 |
| 14.6 | mA | 5.5 | V | 5.32 | V_{AgAgCl} | 24.3 |
| 14.4 | mA | 5.31 | V | 5.31 | V_{AgAgCl} | 24.0 |
| 13 | mA | 5.13 | V | 5 | V_{AgAgCl} | 21.7 |

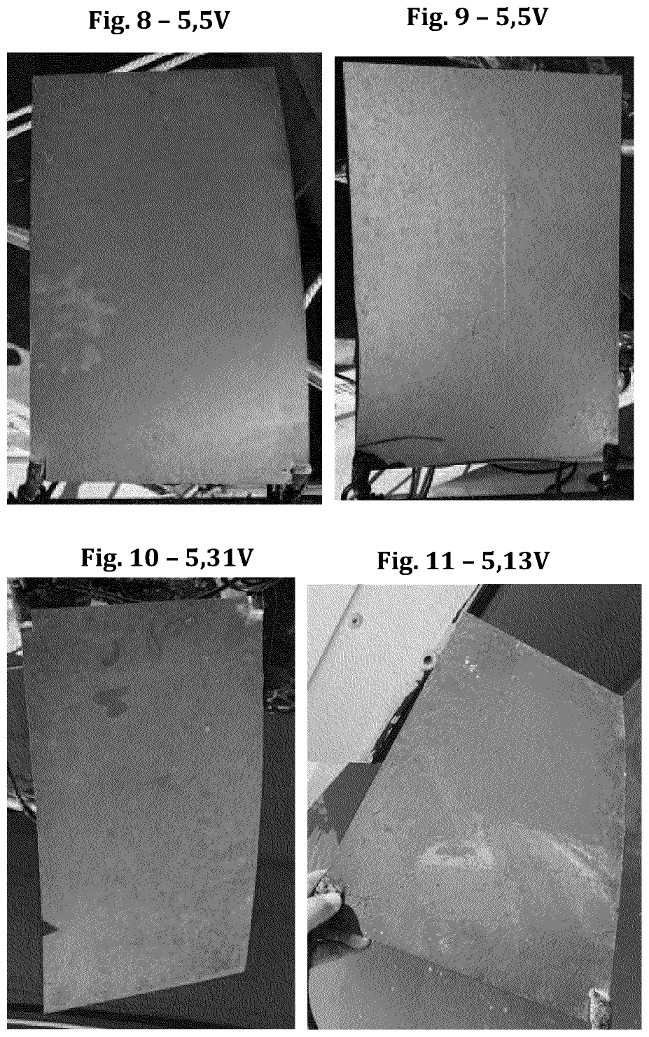

FIGS. 8 to 11 show the plates subjected to these conditions: none of them shows a satisfactory result. We point out that these tensions are already clearly above the voltages suggested in the prior art, and were disclosed as effective in preventing the adhesion of microorganisms. Under these polarization conditions, the plates shown a lower level of biofouling than plates without polarization, but the results are not satisfactory.

Then, tests were carried for tensions above 7V, and the results are summarized in the following table:

| | | | |
|---|---|---|---|
| | Applied | Anode | Current density |
| Current | tension | Potential | mA/m2 |

| | | | | |
|---|---|---|---|---|
| 19 | mA | 7.7 V | 6.61 V_{AgAgCl} | 31.7 |
| 23.4 | mA | 7.5 V | 6.96 V_{AgAgCl} | 39.0 |
| 17.9 | mA | 7.5 V | 7.05 V_{AgAgCl} | 29.8 |
| 19 | mA | 8.2 V | 7.84 V_{AgAgCl} | 31.7 |

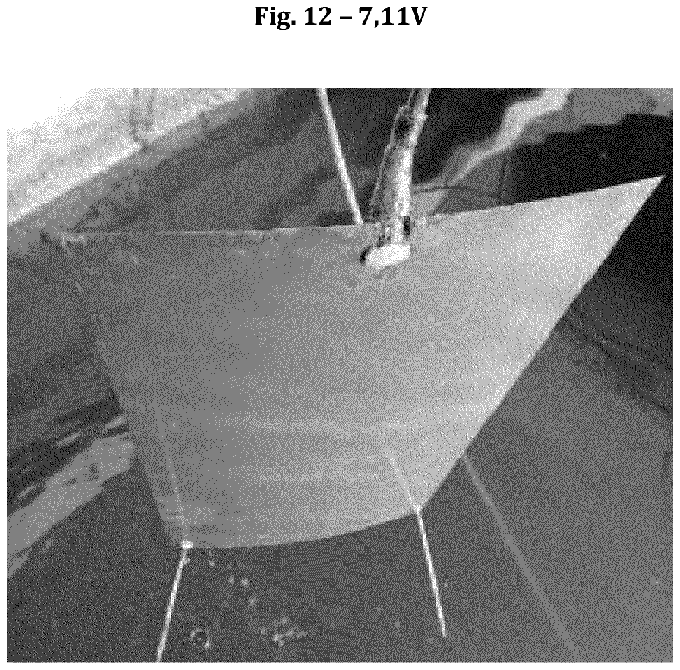

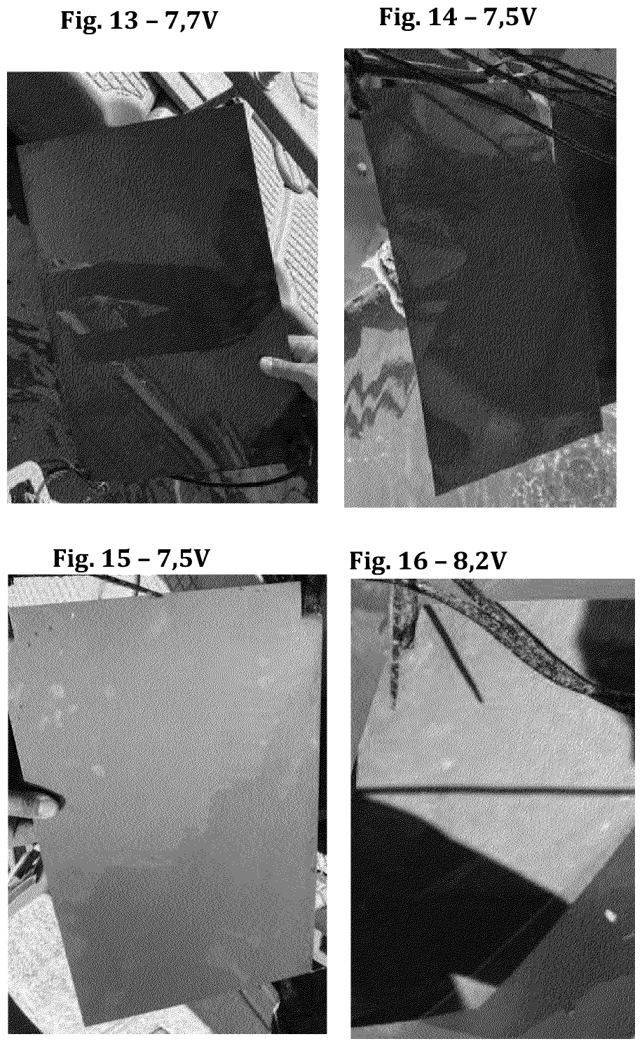

FIGS. 12 to 16 show the plates subjected to these conditions: all of them show practically no microorganisms adhesion.

### Comparison Tests

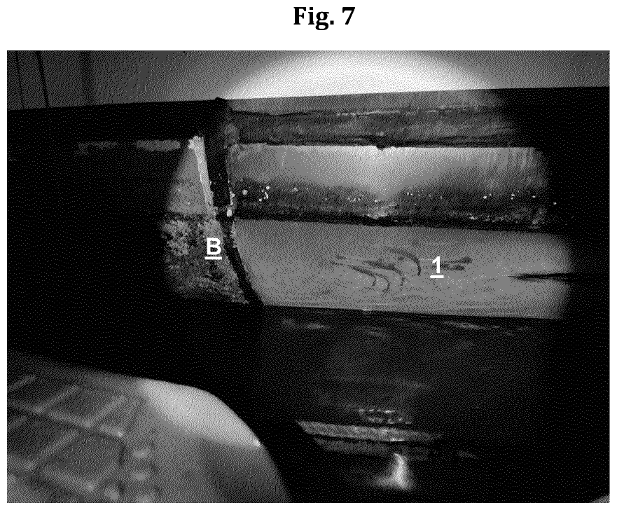

The FIGS. 6 and 7 effect has been achieved by applying a voltage of 7,5 V and a current over 30 mA/square meter during 8 months. The photo shows clearly that there is not a single barnacle B in the titanium.

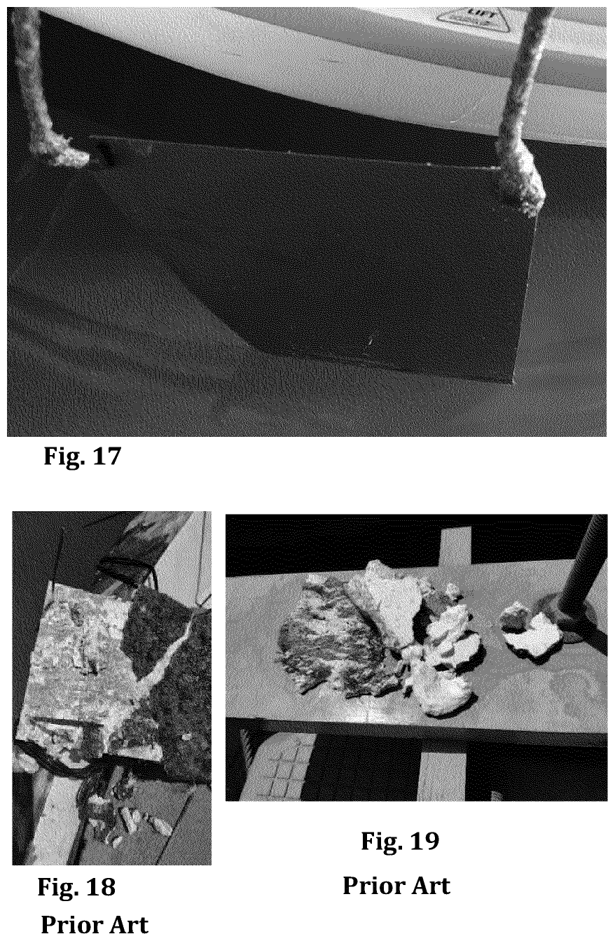

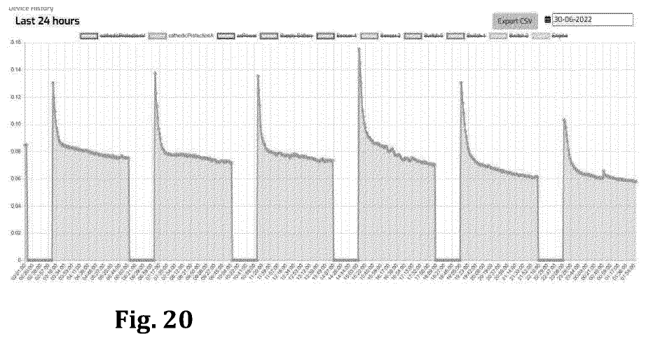

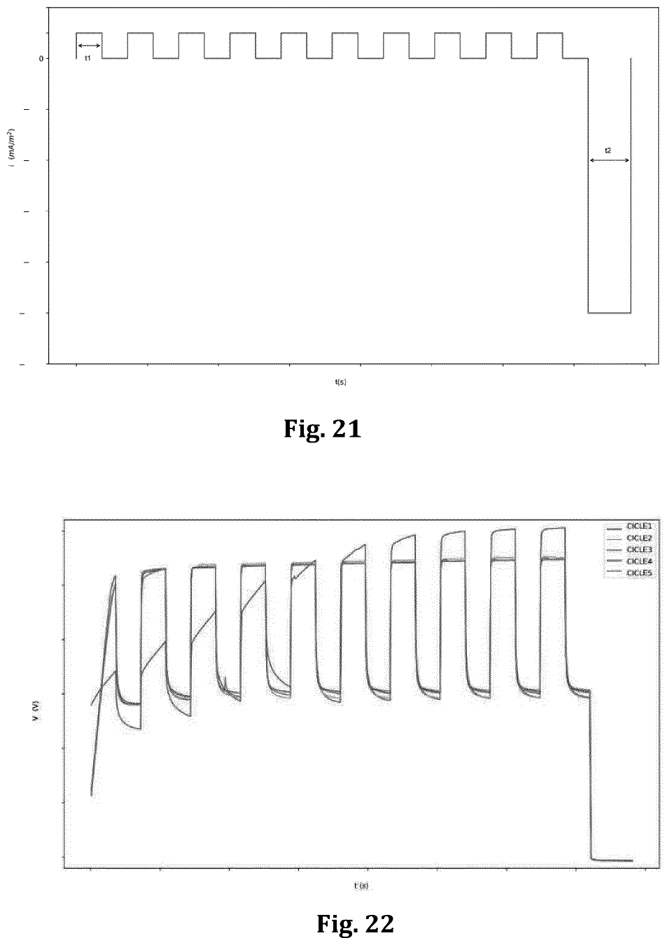

FIG. 17 shows another sample that was immerged for four months, in this case under alternating pulses. Nor a single adhesion was seen on the blank, but the cables, subjected to the same conditions, are fully covered in algae.

Finally, the inventor has developed a layered structure that can be used in the context of the disclosure. This layered structure, which can be considered an disclosure by itself, comprises the following layers:
an underlying substrate made of steel;
a first substrate being made of titanium; and wherein
   the first substrate is made of two layers, an outer thick layer 1E and an attachment layer 1A, the attachment layer 1A forming an interface between the outer layer 1E and the underlying substrate 3, and the attachment layer 1A being a PVD or CVD deposited layer.

This structure can be used among others in ship, pipe, heat exchanger, propeller, shaft, turbines, sea chests, hydrofoils and/or pumps components.

In this layered structure, the first substrate made of titanium can be pure titanium and/or a titanium alloy.

It also can be applied to other metal substrates with insulation systems between metal and titanium sheet or other structural materials such as structural polymers or composite materials.

It is important to highlight that the application of these titanium coatings in order to avoid biofouling is not a trivial concept and in many cases it means making technology accessible and requires special resins, mechanical reinforcement and specific electrical connections, in addition to being necessary to be able to sectioning the surfaces of the components to be kept free of biological incrustation to be able to apply alternating signals and eliminate counter electrodes, reducing electrical consumption, by keeping both electrode and counter electrode clean.

### Inventive Method for Renewing an Anodic Surface

As explained above, to avoid biofouling in submerged structures it is necessary to apply a minimum anode current.

However, by applying this anode current overtime, the resistance of the system increases due to the anodic reactions that occur on the titanium surface (substrate 1) and the work potential required to maintain that current increases until it reaches a stationary state where it is kept constant at values of several positive volts (hence the 6VAg/AgCl indicated above).

Pure titanium has no problem in supporting this working potential, however, titanium alloys with different alloying elements that modify the properties of the native oxide layers present on the surface of titanium alloys, present a lower rupture potential to the potential necessary to maintain an anodic current capable of avoiding the appearance of biological scale and, under these conditions, they degrade. FIG. 27 shows what happens to an alloy when working above the rupture potential.

In order to avoid biological fouling on these alloys, it is necessary to guarantee that the working voltage can be maintained below the mentioned limit (rupture or breakdown potential) with a sufficient safety margin, but ensuring the circulation of a sufficient anode current to prevent biofouling.

To achieve these two objectives, the inventors have validated a method for renewing the anodic surface of the substrate 1 by applying a sufficient cathodic signal that allows the decrease of the resistance of the system and, therefore, working at working potentials below the rupture potential of the alloy while maintaining the minimum current necessary to avoid the appearance of biofouling.

The intensity and time of the cathodic polarization necessary to decrease the working potential is proportional to the anodic current density that is desired to flow through the system and the cathodic cycles necessary to apply depend on the intensity and time of the anodic cycles.

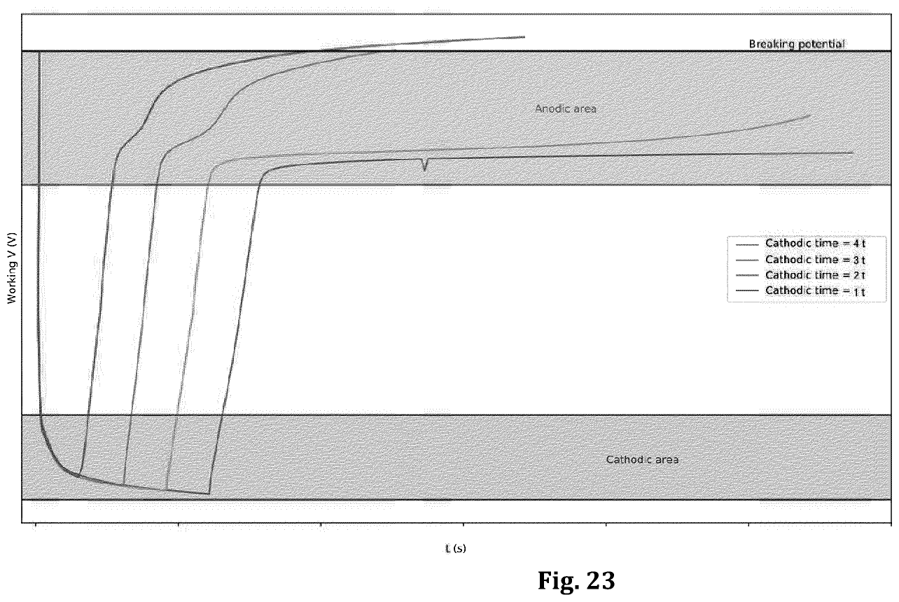

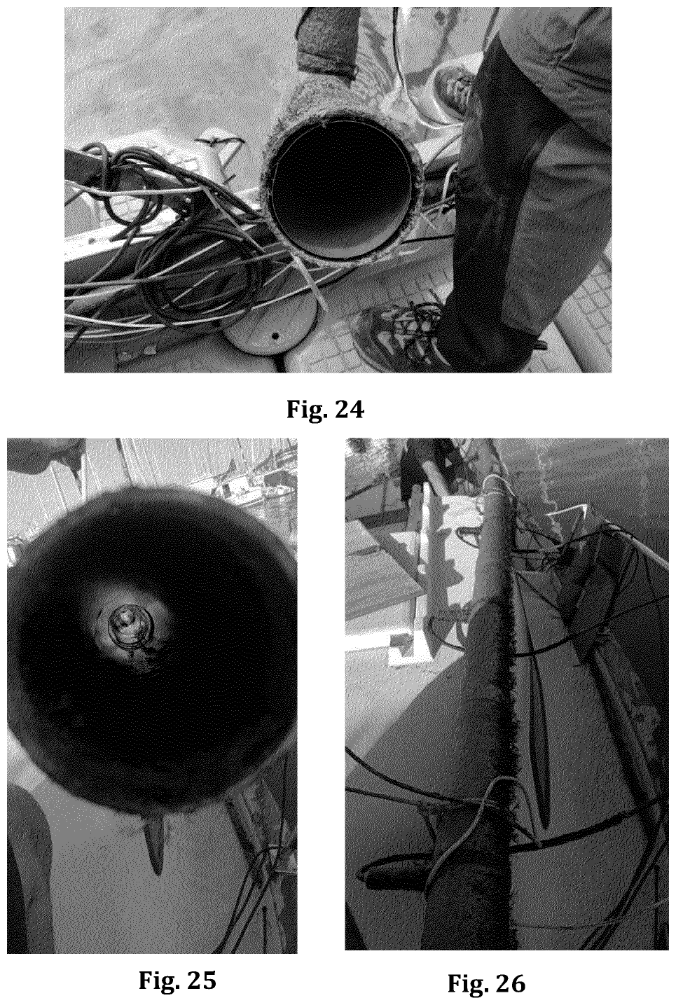

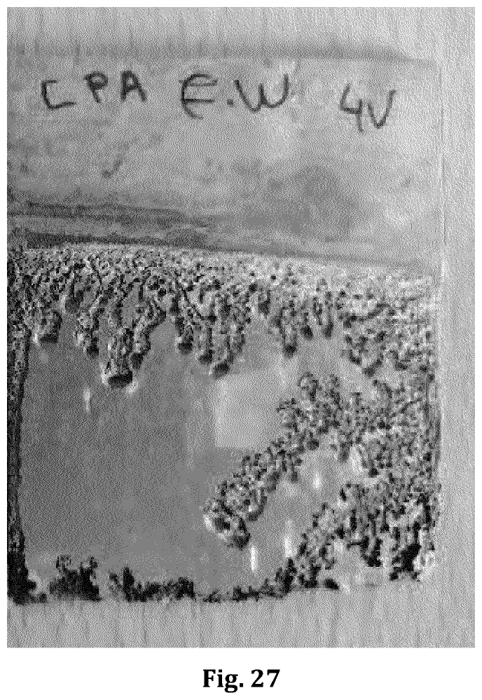

FIG. 23 shows an example of the effect of “cathodic cleaning” on the potential required to work at a given anode current and for a cathode current applied for different times (hence, different cathode charge applied). It is observed that when a sufficient cathodic charge is applied, the working potential stabilizes at a constant value below the limit potential over a period of time.

In FIG. 23 the voltages to maintain an anodic current are represented as a function of time, and the following phases are distinguished therein:
A first phase of anodizing tension, in which the tension is positive and is operated for the protection of scale on the main anodized surfaces. During the anodic stage there is an increase in the resistance of the system due to the anodic reactions produced during the anodic cycle;
In a second phase, the polarity is inverted by applying a cathodic cycle (the working voltage becomes negative) and the substrate starts working as a cathode. During this second phase, surface renewal occurs and anodic processes generated during the anodic polarization phase are reversed;
In a third phase, the polarity is reversed again, forcing the circulation of a sufficient anode current to prevent biofouling. The graph records the electrode potential required to maintain the indicated anode current. It can be observed that insufficient cathodic cycles do not allow the renewal of the surface and the work potential necessary to achieve the minimum anode current necessary to avoid biofouling exceeds the limit potential of the alloy. However, when the cathodic cycle used is large enough, the necessary work potential remains stable for the desired period of time and below the breakdown potential.

These tests show that:
If during the cleaning phase of the cathode the surface has not been completely renewed, the necessary voltage may even be greater than the maximum admissible (rupture or breaking potential). That's because cleaning hasn't been enough;
If the inversion voltage and its application time are properly combined, there comes a time when the necessary subsequent voltage stops increasing: the determination of this combination, for each material, allows the inversion signal to be optimized to guarantee that the anode voltage will be minimal.

Therefore, here another disclosure is disclosed consisting of a method for renewing an anodic surface, comprising the steps of cyclically:
applying a sufficient anodic cycle to avoid biofouling;
applying a cathodic signal sufficient to generate renewal of the surface of the substrate 1 that allows the subsequent application of the anode current necessary to prevent biofouling at potentials below the limit potential;
applying an anode signal for the desired time to achieve the anode current necessary to prevent biofouling at potentials below the breakdown potential.

Preferably these steps are carried out for different values depending on the desired anode current.

In addition, another effect is to be claimed. At sufficiently large cathodic polarizations, the generation of hydrogen occurs on the polarized surface. If it is done with sufficient intensity, it is possible to generate a mechanical cleaning of the surface since a significant amount of bubbles can be generated that can mechanically tear off the biofilm and the bacterial veil.

However, if only this cathodic polarization is carried out, the precipitation of salts is generated and the alloy can be embrittled. That is why it is good to combine it with anode cycles.

Finally, here it is also disclosed a method to eliminate biofouling by mechanically cleaning the submerged surface by applying a cathodic polarization with sufficient voltage as to generate hydrogen bubbles.

In this text, the term “comprises” and its derivations (such as “comprising”, etc.) should not be understood in an excluding sense, that is, these terms should not be interpreted as excluding the possibility that what is described and defined may include further elements, steps, etc.

The disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

1. An electrolytic system for defouling comprising: a first substrate, the first substrate comprising titanium, wherein a surface of the first substrate intended to be in contact with water is defined in the first substrate, a second conductive substrate provided with a surface intended to be in contact with water, the electrolytic system comprising an electrical power source, the electrical power source being connected in series between the first and second substrate, so that an electrolytic circuit is established formed by water, the first substrate, the second substrate and the electrical power source that provides electrical energy, wherein the power source is configured to provide a current density such that the first substrate operates as anode; and
to invert cyclically the polarity of the circuit, such that the first substrate and the second substrate alternate their functions as anodes or cathodes cyclically; and/or
to provide a pulsed current density.

2. The electrolytic system according to claim 1, wherein the second substrate is titanium or activated titanium or a consumable electrode, and/or the electrolytic system comprises a plurality of second substrates and the electrolytic is configured so that at least one of the second substrates is subjected to an anodic potential by the power source, so that at least one of the substrates works as an anode to eliminate the calcareous salts that may have precipitated on its surface.

3. The electrolytic system according to claim 1 wherein the power source is configured to provide a current density greater than or equal to a 30 mA/m² on the surface.

4. The electrolytic system according to claim 1, wherein the electrical power source is configured to apply a cyclic signal consisting in a succession of:
a constant current whereby the first substrate operates as anode and the second substrate operates as cathode; and
an inverted current whereby the first substrate operates as cathode and the second substrate operates as anode.

5. The electrolytic system according to claim 1, wherein the electrical power source is configured to apply a cyclic signal consisting in a succession of:
a pulsed current whereby the first substrate operates as anode and the second substrate operates as cathode; and
an inverted current whereby the first substrate operates as cathode and the second substrate operates as anode.

6. The electrolytic system according to claim 1, which comprises an underlying substrate, the first substrate being attached to the underlying substrate.

7. The electrolytic system according to claim 1, wherein the underlying substrate is made of steel, aluminium or bronze, the first substrate being made of pure titanium, and wherein the first substrate is made of two layers, an outer thick layer and an attachment layer, the attachment layer forming an interface between the outer layer and the underlying substrate, and preferably the attachment layer is a PVD or CVD deposited layer.

8. The electrolytic system according to claim 1, wherein the underlying substrate is made of a titanium alloy, the first substrate being made of pure titanium.

9. The electrolytic system according to claim 1, wherein the underlying substrate is made of a composite material, the first substrate being a blank made of pure titanium and having a thickness comprised between 0.1 and 4 mm.

10. The electrolytic system according to claim 9, wherein the composite material comprises resins, glass fibre, carbon fibre and/or structural plastic.

11. The electrolytic system according to claim 6, wherein the underlying substrate is made of an inner layer made of metal and an outer layer made of isolation material, the first substrate being a blank made of pure titanium and having a thickness comprised between 0.1 and 4 mm, the blank being attached to the outer layer.

12. The electrolytic system according to claim 1, wherein the first substrate is divided in a plurality of substrates, such that some of the substrates form the second substrate when inversions of polarity apply.

13. A ship, pipe, heat exchanger, propeller, shaft, turbines, sea chests, hydrofoils and/or pumps components provided with an electrolytic system according to claim 12.

14. An assembly comprising a pipe and an electrolytic system according to claim 1, comprising an inner layer that corresponds to the first substrate, the pipe comprising an intermediate layer that corresponds to a structural material to confer it rigidity, and comprising an outer metallic layer that corresponds to the second substrate.

15. A method for defouling a ship, pipe, heat exchanger, propeller, shaft, turbines, sea chests, hydrofoils and/or pumps components according to claim 12, the method includes the following steps:
calculating the first substrate area;
setting the electrical power source such that it provides preferably an anode potential greater than a limit to avoid biofouling in the first substrate;
with plurality of second substrates and the electrolytic is configured so that at least one of the second substrates is subjected to the same potential by the power source as the first substrate, so that this at least one of the substrates works as an anode to eliminate the calcareous salts that may have precipitated on its surface;
or divided the first substrate in a plurality of substrates and inverting the polarity between those substrates so that all the substrate act as anodes and cathodes avoiding biofouling growth on their surfaces, the precipitation of calcareous salts on their surface, avoid the needs of additional counter electrodes and reduce the working area and therefore the energy consumption.

16. A method for renewing an anodic surface, the method including the following steps of cyclically:
applying a sufficient anodic cycle to avoid biofouling;
applying a cathodic signal sufficient to generate renewal of the surface of the substrate that allows the subsequent application of the anode current necessary to prevent biofouling at potentials below the breakdown potential; and
applying an anode signal for the time needed to achieve the anode current necessary to prevent biofouling at potentials below the breakdown potential.

17. The method according to claim 16, which is carried out for different values depending on the needed anode current.

18. A biofouling removal method by hydrogen bubble generation through cathodic polarization.
